(19) United States
(12) Patent Application Publication
(10) Pub. No.: US 2009/0292391 A1
(43) Pub. Date: Nov. 26, 2009

(54) BASKET HOUSING RACK SYSTEM AND METHOD FOR CONTROLLING THE BASKET HOUSING RACK SYSTEM

(75) Inventor: Naoto Yoshizawa, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/468,898

(22) Filed: May 20, 2009

(30) Foreign Application Priority Data
May 21, 2008 (JP) 2008-133680

(51) Int. Cl. G06F 7/00; A47F 7/00; A47F 9/04

(52) U.S. Cl. 700/219; 211/71.01; 186/62

(57) ABSTRACT

In a checkout counter, a first apparatus is arranged on an entrance side and a second apparatus is arranged on an exit side. Both the first apparatus and the second apparatus are basket housing rack apparatuses of the same type. The basket housing rack apparatuses drive, with driving units, racks attached to bases, which are set on a floor surface, to be freely raised and lowered and raise and lower the racks. Placing sections of the racks set the height of a shopping basket at the top to, for example, the height of a checkout counter and stackably place plural shopping baskets. Control units control to drive the driving units according to a trigger signal such as a closing signal transmitted from a POS terminal, lower the rack of the first apparatus by the height of one shopping basket, and raise the rack of the second apparatus by the height of one shopping basket.

### CROSS REFERENCE TO RELATED APPLICATION

This application is based upon and claims the benefit of priority from Japanese Patent Application No. P2008-133680, filed on May 21, 2008, the content of which is incorporated herein by reference.

### TECHNICAL FIELD

The present invention relates to a basket housing rack system used in a checkout counter and a method for controlling the basket housing rack system.

### BACKGROUND

A store such as a supermarket includes plural checkout counters near an exit of a commodity display floor. Each of the checkout counters include a code reader installed in the center thereof. A customer places, on the checkout counter, a shopping basket in which commodities that the customer purchases are stored. The shopping basket is located further to the front (the display floor side of the commodities) than the code reader. A store clerk takes out the commodities from the shopping basket and directs code symbols of the commodities to a front surface of the code reader. The code reader reads the code symbols of the commodities. The store clerk moves the commodities away from the front surface of the code reader and puts the commodities one after another in another shopping basket placed on the checkout counter in advance. The other shopping basket is located ahead of the code reader (on the exit side).

The code reader is placed between the two shopping baskets on the checkout counter. The code reader reads the code symbols of the commodities moved from the shopping basket on the display floor side to the shopping basket on the exit side on the checkout counter. After paying for the commodities, in order to pack the purchased commodities in a bag by herself or himself, the customer carries the shopping basket, in which the commodities are stored, away from the checkout counter. The store clerk moves the emptied shopping basket on the display floor side to the exit side and prepares for the next transaction.

In such a store, the customer carries a shopping basket, which is carried in to the checkout counter by the preceding customer, away from the checkout counter together with the commodities that the customer purchases. Therefore, the shopping basket does not stay in the checkout counter. However, before taking out the commodities from the shopping basket carried in to the checkout counter by the customer, the store clerk has to move an emptied basket from one side (the display floor side) of the checkout counter to the other side (the exit side).

While moving the emptied shopping basket in this way, the store clerk cannot start checkout work. In other words, work for moving the emptied shopping basket by the store clerk deteriorates efficiency of a checkout job.

JP-A-07-313314 proposes, aiming at elimination of such inconvenience, to set a collecting apparatus for a shopping basket on a display floor side of a checkout counter and set a packing apparatus on an exit side of the checkout counter. The collecting apparatus has a function of holding, in a stacked state, several shopping baskets carried in to the checkout counter by customers and raising and lowering the shopping baskets. The apparatus performs operation control for the raising and lowering function such that a height position of a shopping basket stacked at the top of a certain or smaller number of shopping baskets in the stacked state is at certain height. When the height position of the shopping basket stacked at the top is higher than a first reference position, the apparatus lowers the held shopping baskets by the height exceeding the first reference height to thereby keep the height of the stacked shopping baskets at the first reference height. Therefore, the store clerk does not have to move an emptied shopping basket every time the shopping basket is emptied.

However, the collecting apparatus is effective only when the packing apparatus is set on the exit side of the checkout counter.

Packing work for commodities takes time and labor. This is because a store clerk pays attention to order of storing commodities and a way of packing the commodities in order to prevent crush, unfastening, and the like of the commodities. When the store clerk performs the packing work on the checkout counter, the store clerk cannot start checkout work during the packing work. Therefore, efficiency of checkout is deteriorated.

Therefore, in most stores, the packing work for commodities in the checkout counter is abolished. A customer is asked to pack purchased commodities in a bag by herself or himself in a place away from the checkout counter. To pack the commodities, the customer has to carry the purchased commodities from the checkout counter by herself or himself. Naturally, the customer desires to carry the purchased commodities away from the checkout counter with the commodities put in a shopping basket in the same manner as the customer carries the commodities to be purchased to the checkout counter. It is useful to use a shopping basket carried in to the checkout counter and emptied by the preceding customer.

However, among the stores that adopt an operation in which the packing work for commodities in the checkout counter is abolished and a customer carries commodities purchased by the customer away from the checkout counter, no store successfully reduces a work load on a store clerk and improves efficiency of checkout work.

### SUMMARY

It is an object of the present invention to reduce a work load of work for moving an emptied shopping basket to an exit side of a checkout counter in a store that adopts an operation in which a customer carries purchased commodities purchased by the customer, which are put in the emptied shopping basket, away from the checkout counter.

According to an aspect of the present invention, there is provided a basket housing rack system including: a first apparatus as a basket housing rack apparatus including a base set on a floor surface, a rack that is attached to the base to be freely raised and lowered and has a placing section for setting the height of a shopping basket at the top to certain reference height and stackably placing plural shopping baskets, and a driving unit that drives to raise and lower the rack; a second apparatus same as the basket housing rack apparatus; and control units that control to drive the driving unit of the first apparatus to lower the rack of the first apparatus and control to drive the driving unit of the second apparatus to raise the rack of the second apparatus according to a trigger signal transmitted from a commodity sales data processing apparatus.

According to another aspect of the present invention, there is provided a basket housing rack apparatus control method for a pair of basket housing rack apparatuses including bases set on a floor surface, racks that are attached to the bases to be freely raised and lowered and have placing sections for setting height of a shopping basket at a top to certain reference height and stackably placing plural shopping baskets, and driving units that drive to raise and lower the racks, a central control apparatus being connected to the basket housing rack apparatuses to be capable of transmitting a signal via a first connecting unit and a second connecting unit, respectively, and having a checkout counter set at certain reference height on an upper surface thereof, the basket housing rack apparatus control method including: the central control apparatus receiving a trigger signal transmitted from a commodity sales data processing apparatus; the central control apparatus controlling to drive the driving unit of the basket housing rack apparatus to lower the rack of the basket housing rack apparatus connected to the first connecting unit according to the received trigger signal; and the central control apparatus controlling to drive the driving unit of the basket housing rack apparatus to raise the rack of the basket housing rack apparatus connected to the second connecting unit.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of operation of a system according to an embodiment of the present invention;

FIG. 2 is a plan view of the entire system according to the embodiment;

FIG. 3A is a schematic diagram of a raising and lowering mechanism of a basket housing rack apparatus in a state in which a rack according to the embodiment is lowered most;

FIG. 3B is a schematic diagram of the raising and lowering mechanism of the basket housing rack apparatus in a state in which the rack according to the embodiment is raised most;

FIG. 4 is a circuit diagram of a hydraulic circuit of a driving unit according to the embodiment;

FIG. 5 is a block diagram of electric connection of units according to the embodiment;

FIG. 6 is a perspective view of a first connecting unit that connects a checkout counter (a central control apparatus) and the basket housing rack apparatus according to the embodiment;

FIG. 7 is a longitudinal sectional side view of the structure of a communication connector among connectors of the basket housing rack apparatus according to the embodiment; and

FIG. 8 is a flowchart of a flow of processing in the checkout counter (the central control apparatus) and basket housing rack apparatuses (a first apparatus and a second apparatus) according to the embodiment.

### DETAILED DESCRIPTION

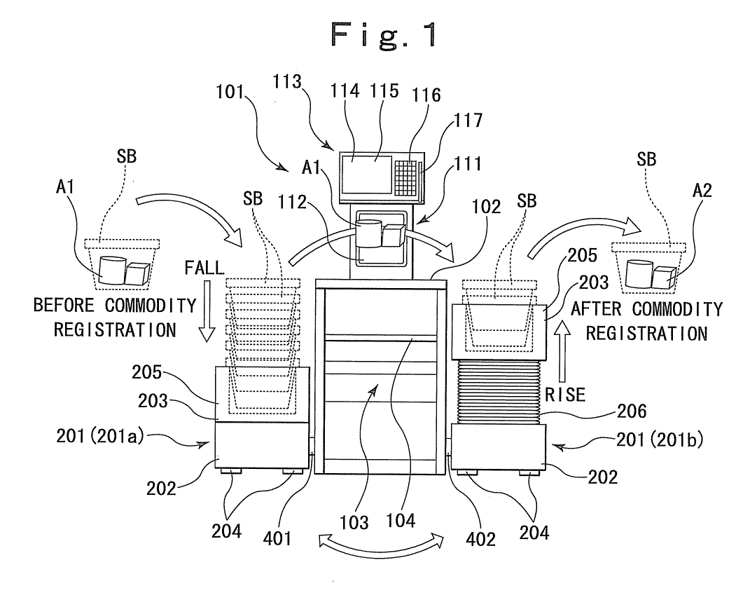

An embodiment of the present invention is explained with reference to FIGS. 1 to 8.

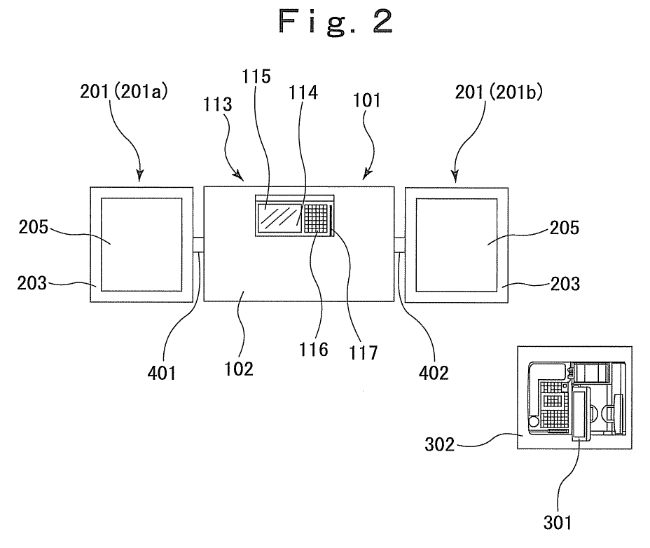

As shown in FIG. 1, a system according to this embodiment includes a checkout counter 101 as a central control apparatus. In this system, a first apparatus 201a and a second apparatus 201b as basket housing rack apparatuses 201 are arranged on both sides of the checkout counter 101. A POS terminal 301 (see FIG. 2) as a commodity sales data processing apparatus is arranged near the second apparatus 201b.

As shown in FIG. 2, the checkout counter 101 and the first apparatus 201a and the second apparatus 201b as the two basket housing rack apparatuses 201 are arranged in a row. Both the first apparatus 201a and the second apparatus 201b are the basket housing rack apparatuses 201 having completely the same configuration. The basket housing rack apparatus 201 set on an entrance side of the checkout counter 101 functions as the first apparatus 201a. The basket housing rack apparatus 201 set on an exit side of the checkout counter 101 functions as the second apparatus 201b. The POS terminal 301 is placed on a terminal table 302 and is arranged with a direction thereof changed to be perpendicular to the checkout counter 101 and the two basket housing rack apparatuses 201. Therefore, the checkout counter 101 and the basket housing rack apparatuses 201 arranged in a row and the POS terminal 301 are arranged in an L shape.

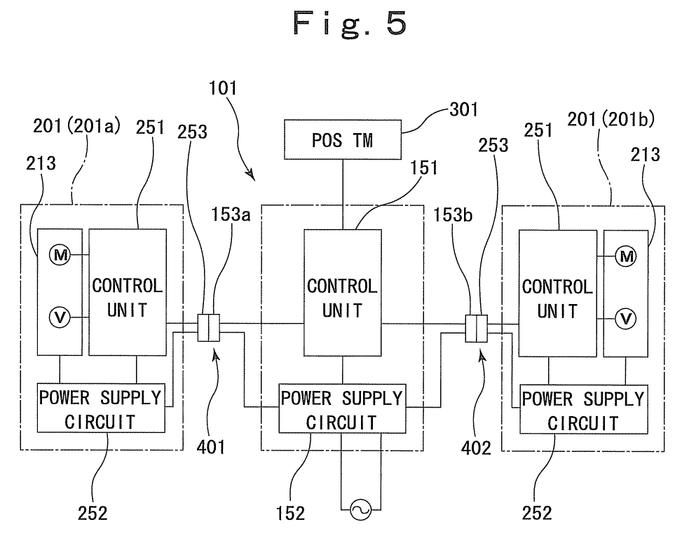

As shown in FIG. 1, the checkout counter 101 includes a counter top plate 102 on an upper surface thereof and incorporates a control unit 151 (see FIG. 5) in a lower area thereof. The checkout counter 101 has a housing space 103 in sections other than a housing area for the control unit 151. The housing space 103 is partitioned into two stages by a shelf board 104 and houses, for example, various articles used in checkout processing.

The checkout counter 101 includes a barcode reader 111 on the counter top plate 102. As shown in FIG. 2, the barcode reader 111 is located on an inner side (a customer side) of the counter top plate 102. The barcode reader 111 is a vertical scanner including a scan window 112 directed to a store clerk side. The barcode reader 111 includes an operation display unit 113 in an upper part thereof. The operation display unit 113 includes a liquid crystal display 115, on the surface of which a touch panel 114 is arranged. The operation display unit 113 includes a keyboard 116 of a membrane type on the right of the liquid crystal display 115 and includes a card scan groove 117 on the right of the keyboard 116.

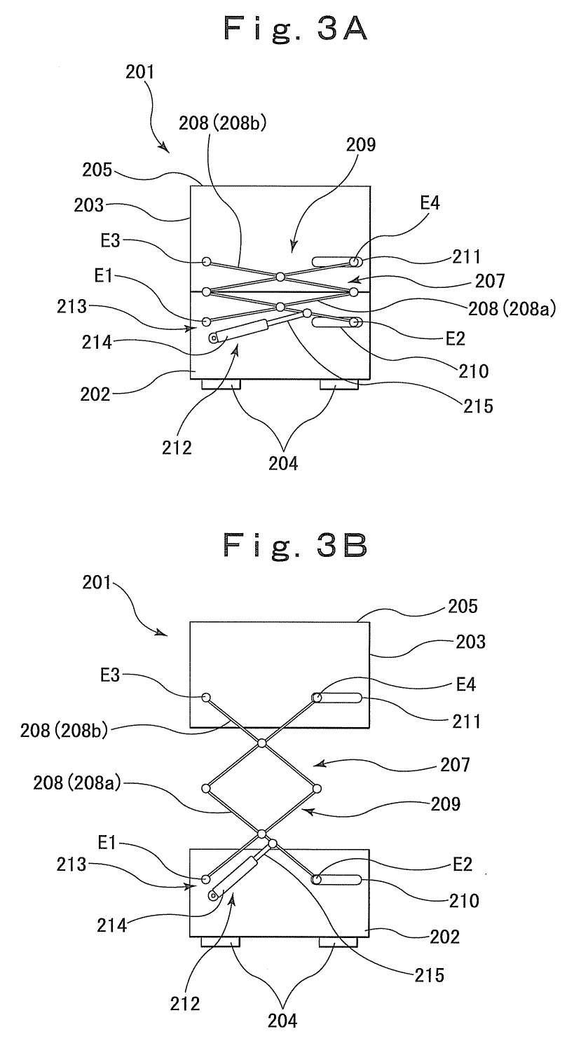

As shown in FIG. 1, the basket housing rack apparatus 201 includes a base 202 set on a floor surface. The base 202 includes a rack 203 in an upper part thereof. The rack 203 is freely raised and lowered by the base 202. The base 202 includes casters 204 at four corners in a lower part thereof and can smoothly move. The rack 203 is a bottomed box-shaped member with an opened upper surface. The rack 203 functions as, because of the box shape, a placing section 205 for stackably placing plural shopping baskets SB. The base 202 and the rack 203 are coupled by a coupling screen 206 formed in a bellows shape. The coupling screen 206 is collapsible and expands and contracts according to raising and lowering operation of the rack 203 relative to the base 202. The coupling screen 206 plays a role of hiding a raising and lowering mechanism 207 (see FIGS. 3A and 3B) that couples the base 202 and the rack 203.

As shown in FIGS. 3A and 3B, the raising and lowering mechanism 207 includes a pantograph mechanism 209 in which plural links 208 are pivotably coupled in a bellows shape. In the plural links 208, a pair of link pairs 208a and 208b, which form an X shape with intermediate sections thereof pivotably coupled, are pivotably coupled to each other to form the pantograph mechanism 209. Two free ends E1 and E2 of the link pair 208a located in a lower part are pivotably coupled to the base 202. Two free ends E3 and E4 of the link pair 208b located in an upper part are pivotably coupled to the rack 203. The base 202 includes a lower long hole 210 elongated in the horizontal direction. One free end E2 of the link pair 208a located in the lower part is slidably coupled to the lower long hole 210. The rack 203 includes an upper long hole 211 elongated in the horizontal direction. The upper long hole 211 is parallel to the lower long hole 210. One free end E4 of the link pair 208b located in the upper part is slidably coupled to the upper long hole 211. A pair of the pantograph mechanisms 209 couple the base 202 and the rack 203 on each of a front side and a rear side of the basket housing rack apparatus 201.

The pantograph mechanism 209 performs expanding and contracting action when one free end E2 of the pair of link pairs 208a located in the lower part slides in the lower long hole 210 and one free end E4 of the other link pairs 208b slides in the upper long hole 211. The rack 203 is located to be freely raised and lowered in a certain position between a lowered position (see FIG. 3A) and a raised position (see FIG. 3B) according to the expanding and contracting action of the pantograph mechanism 209.

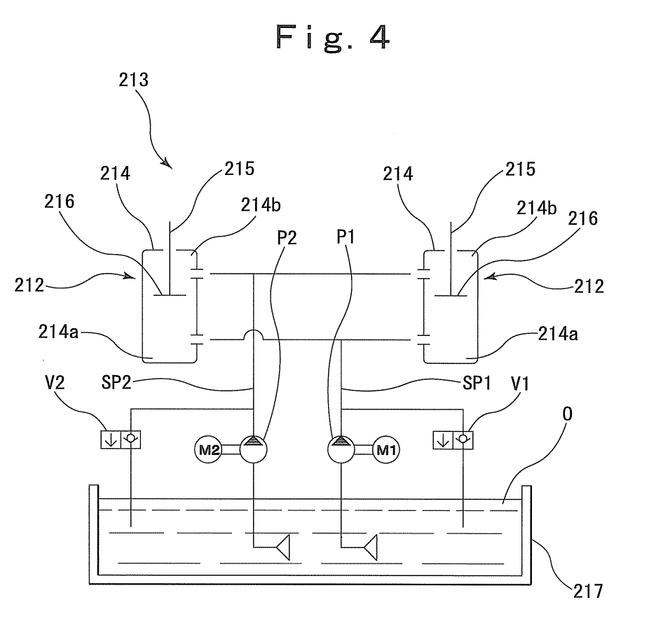

The raising and lowering mechanism 207 uses a driving unit 213 (see FIG. 4) as a driving source for applying driving force to the pantograph mechanism 209 and realizing expansion and contraction of the pantograph mechanism 209. A driving unit 213 is a hydraulic driving mechanism mainly including a hydraulic cylinder 212. The hydraulic cylinder 212 has general structure in which a rod 215 is housed in a cylinder 214 to freely expand and contract with the force of oil pressure of the rod 215. The side of the cylinder 214 is pivotably coupled to the base 202. The side of the rod 215 is pivotably coupled to one link 208 that configures the link pair 208a located in the lower part. The link 208 is the link 208 having the free end E2. Therefore, the free end E2 moves in a direction away from the free end E1 when the rod 215 ejects from the cylinder 214. The pantograph mechanism 209 is folded according to the movement of the free end E2 and the rack 203 falls (see FIG. 3A). The free end E2 moves in a direction closer to the free end E1 when the rod 215 is drawn into the cylinder 214. The pantograph mechanism 209 expands according to the movement of the free end E2 and the rack 203 rises (see FIG. 3B).

FIG. 4 is a circuit diagram of a hydraulic circuit of the driving unit 213. In the cylinder 214 of the hydraulic cylinder 212, a lower chamber 214a and an upper chamber 214b are separated by a piston 216 fixed to an end of the rod 215 in the cylinder 214. A pump P1 supplies oil O stored in an oil reservoir 217 to the lower chamber 214a of the cylinder 214. A motor M1 drives the pump P1. The driving unit 213 includes an electromagnetic valve V1 in a supply path SP1 leading to the lower chamber 214a of the cylinder 214. A motor M2 drives a pump P2. The pump P2 supplies the oil O to the upper chamber 214b of the cylinder 214. The driving unit 213 includes an electromagnetic valve V2 in a supply path SP2 leading to the upper chamber 214b of the cylinder 214. The driving unit 213 drives the motor M1 to actuate the pump P1 in a state in which the electromagnetic valve V1 is closed. In actuating the pump P1, the driving unit 213 opens the electromagnetic valve V2. Then, the hydraulic cylinder 212 can supply, while permitting the oil O to escape from the upper chamber 214b of the cylinder 214, the oil O to the lower chamber 214a and drive the rod 215 in a projecting direction. Conversely, the driving unit 213 drives the motor M2 to actuate the pump P2 in a state in which the electromagnetic valve V2 is closed. In actuating the pump P2, the driving unit 213 opens the electromagnetic valve V1. Then, the hydraulic cylinder 212 can supply, while permitting the oil O to escape from the lower chamber 214a of the cylinder 214, the oil O to the upper chamber 214b and drive the rod 215 in a retracting direction. In this way, the driving unit 213 can drive to raise and lower the rack 203.

FIG. 5 is a block diagram of electric connection of units. As explained above, the checkout counter 101 includes the control unit 151. The control unit 151 is a processor that sequentially executes various processes and is a digital circuit including an integrated circuit. The control unit 151 executes sequential processing processes in order while temporarily storing temporary data and the like in a resist area (not shown in the figure). The control unit 151 of the checkout counter 101 is connected to the POS terminal 301 and executes data transmission and reception with the POS terminal 301.

The basket housing rack apparatuses 201 include control units 251. Like the control unit 151, the control units 251 are processors that sequentially execute various processes and are digital circuits including integrated circuits. The control units 251 are connected to the motors M (M1 and M2) and the electromagnetic valves V (V1 and V2) that configure the driving units 213 explained above. The driving units 213 control to drive the motors M (M1 and M2) and the electromagnetic valves V (V1 and V2). The driving units 213 execute sequential processing processes in order while temporarily storing temporary data and the like in resist areas (not shown in the figure).

The checkout counter 101 and the basket housing rack apparatuses 201 include power supply circuits 152 and 252, respectively, in order to feed power to the units thereof. The power supply circuit 152 is a power feeding circuit for the control unit 151 of the checkout counter 101 and is connectable to a commercial power supply. The power supply circuit 152 rectifies and smoothes AC power supplied from the commercial power supply and supplies the rectified and smoothed power to the control unit 151. The power supply circuits 252 are power feeding circuits for the control units 251 and the driving units 213 of the basket housing rack apparatuses 201. Power is fed to the power supply circuits 252 from the power supply circuit 152 of the checkout counter 101. The power supply circuit 152 directly supplies the AC power, which is supplied from the commercial power supply, to the power supply circuits 252. The power supply circuits 252 rectify and smooth the AC power and supply the rectified and smoothed power to the control units 251 and the electromagnetic valves V (V1 and V2) of the driving units 213. Further, the power supply circuits 252 invert the rectified and smoothed power into AC power using inverters (not shown in the figure) and supply the AC power to the motors M (M1 and M2) of the driving units 213.

The checkout counter 101 and the basket housing rack apparatuses 201 can be connected by a first connecting unit 401 and a second connecting unit 402. The first and second connecting units 401 and 402 can transmit a signal between the control unit 151 of the checkout counter 101 and the control units 251 of the basket housing rack apparatuses 201. Further, the first and second connecting units 401 and 402 have power feeding connection structures. The first and second connecting units 401 and 402 include two connectors 153a and 153b provided on the side of the checkout counter 101. The first and second connecting units 401 and 402 also include two connectors 253 connectable to the connectors 153a and 153b respectively. The connectors 253 are provided on both sides of the basket housing rack apparatuses 201.

The first connecting units 401 and 402 have not only communication connection structures but also power feeding connection structures. The connectors 153a and 153b of the checkout counter 101 are connected to the control unit 151 and the power supply circuits 152. The connectors 253 of the basket housing rack apparatuses 201 are connected to the control units 251 and the power supply circuits 252.

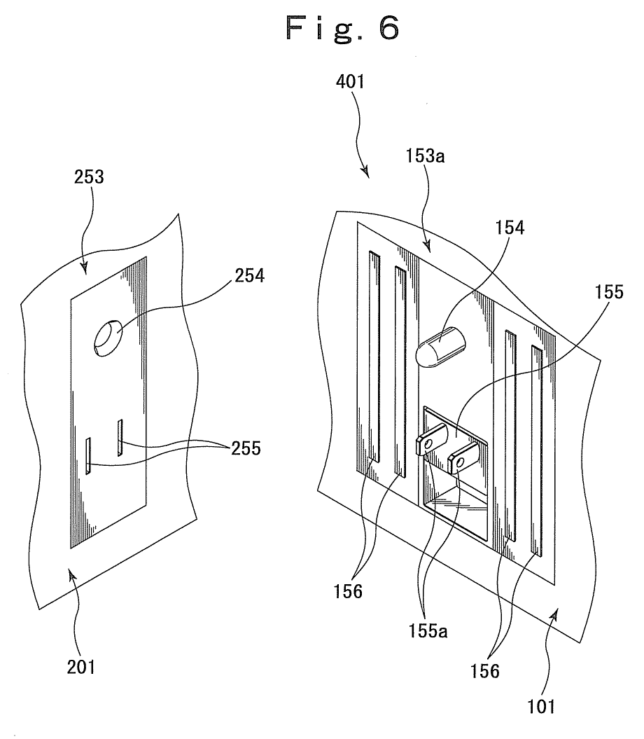

FIG. 6 is a perspective view of the first connecting unit 401 that connects the checkout counter 101 and the basket housing rack apparatus 201. The connector 153a on the side of the checkout counter 101 includes a connection pin 154 for communication and an attachment plug 155 for power feeding. The connection pin 154 has structure projecting in a bar shape. The attachment plug 155 freely pivots between a horizontal direction and a vertical downward direction. When not in use, the attachment plug 155 can be housed in the vertically downward direction.

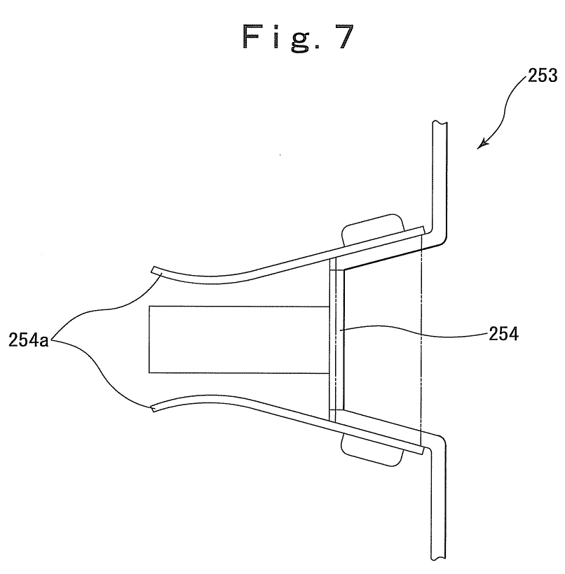

FIG. 7 is a longitudinal sectional side view of the structure of a connector for communication in the connector 253 of the basket housing rack apparatus 201. As shown in FIG. 6, the connector 253 on the side of the basket housing rack apparatus 201 includes a pin hole 254 through which the connection pin 154 can be inserted and outlet holes 255 to which the attachment plug 155 can be connected. The pin hole 254 has a slightly hollow shape to make it easy to insert the connection pin 154. Connection pieces 254a conductively connected to the connection pin 154 inserted in the pin hole 254 are provided in the inner part of the pin hole 254 (see FIG. 7). The connection pieces 254a are plural metal elastic pieces collected narrower than the diameter of the pin hole 254. When the connection pin 154 is inserted in the pin hole 254, the metal elastic pieces forming the connection pieces 254a are elastically deformed by the inserted connection pin 154 and maintain a state in which the metal elastic pieces are in press contact with the connection pin 154. The outlet holes 255 are provided wider than the width of connection pieces 155a of the attachment plug 155. Regardless of which position the connection pieces 155a are inserted, the output holes 255 make it possible to conductively connect connection conductors (not shown in the figure) provided in the inside of the outlet holes 255 and the connection pieces 155a.

As shown in FIG. 6, the connector 153a on the side of the checkout counter 101 includes a pair of magnets 156 on each of sides of the connector 153a. When the basket housing rack apparatus 201 is arranged adjacent to the checkout counter 101 in order to connect the connector 153a and the connector 253, the magnet 156 magnetically attracts the base 202 made of, for example, sheet metal of the basket housing rack apparatus 201 and stabilizes a connection state.

In FIG. 6, the connector 153a forming the first connecting unit 401 is shown as a connector on the side of the checkout counter 101. The connector 153b forming the second connecting unit 402 has a shape and structure same as those of the connector 153a shown in FIG. 6. On the other hand, the basket housing rack apparatus 201 only has the one connector 253. The connector 253 is a connector forming the first connecting unit 401 in some situation and is a connector forming the second connecting unit 402 in another situation. Specifically, when the connector 253 of the basket housing rack apparatus 201 is connected to one connector 153a of the checkout counter 101 forming the first connecting unit 401, the connector 253 forms the first connecting unit 401. When the connector 253 is connected to the other connector 153b of the checkout counter 101 forming the second connecting unit 402, the connector 253 forms the second connecting unit 402.

As shown in FIG. 2, the two basket housing rack apparatuses 201 are located on both the sides of the checkout counter 101, respectively. In FIG. 2, the first connecting unit 401 connects the checkout counter 101 and the basket housing rack apparatus 201 on the left side of the checkout counter 101. The second connecting unit 402 connects the checkout counter 101 and the basket housing rack apparatus 201 on the right side of the checkout counter 101. Both the first and second connecting units 401 and 402 are located in side center positions between the checkout counter 101 and the basket housing rack apparatuses 201. Therefore, when the store clerk connects the connector 253 of the basket housing rack apparatus 201 to one connector 153a forming the first connecting unit 401, the store clerk locates the basket housing rack apparatus 201 such that the connector 253 faces the right side (on the paper surface of FIG. 2). When the store clerk connects the connector 253 of the basket housing rack apparatus 201 to the other connector 153b forming the second connecting unit 402, the store clerk locates the basket housing rack apparatus 201 such that the connector 253 faces the left side (on the paper surface of FIG. 2). When the two basket housing rack apparatuses 201 are located with respect to the checkout counter 101 as shown in FIGS. 1 and 2, both the first and second connecting units 401 and 402 maintain the connection state.

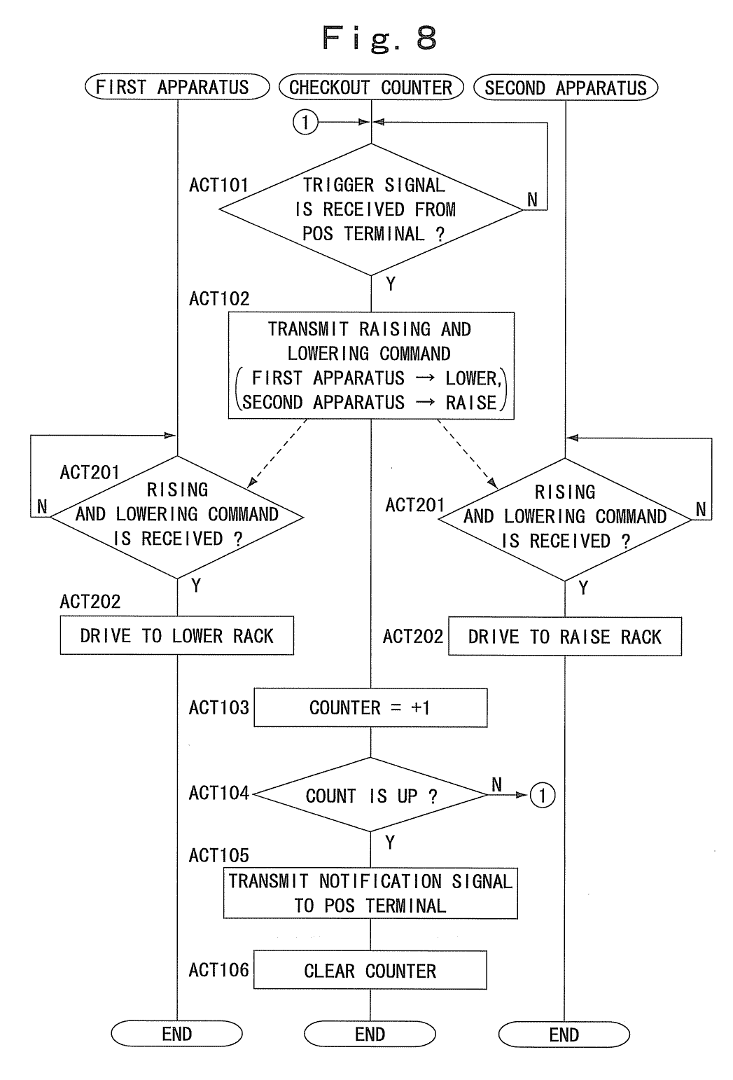

The control unit 151 of the checkout counter 101 treats, as the first apparatus 201a, the basket housing rack apparatus 201 connected to the first connecting unit 401 and treats, as the second apparatus 201b, the basket housing rack apparatus 201 connected to the second connecting unit 402. The control unit 151 selectively sets, without requiring any setting operation, the basket housing rack apparatuses 201 as the first apparatus 201a and the second apparatus 201b simply by connecting the connectors 253 of the basket housing rack apparatuses 201 to the connector 153a forming the first connecting unit 401 and the connector 153b forming the second connecting unit 402. Meaning of this setting is further clarified with reference to a flow chart of FIG. 8.

FIG. 8 is a flowchart of a flow of processing in the checkout counter 101 and the basket housing rack apparatuses 201 (the first apparatus 201a and the second apparatus 201b). The control unit 151 of the checkout counter 101 stands by for reception of a trigger signal from the POS terminal 301 (ACT 101). The trigger signal in this case is, as an example, a closing signal and, as another example, a commodity code reading signal (a transaction start signal) for starting one transaction. When a subtotal key is depressed or a deposit and cash total key is depressed after an amount of deposit is input from a customer, the POS terminal 301 generates a closing signal and transmits the closing signal to the checkout counter 101. Alternatively, when the POS terminal 301 receives read data of a barcode from the barcode reader 111 before one transaction is started, the POS terminal 301 generates a commodity code reading signal (a transaction start signal) for starting one transaction and transmits the commodity code reading signal to the checkout counter 101.

When the control unit 151 of the checkout counter 101 determines that the trigger signal is received from the POS terminal 301 (Y in ACT 101), the control unit 151 transmits a raising and lowering command to the first apparatus 201a and the second apparatus 201b (ACT 102). The control unit 151 treats, as the first apparatus 201a, the basket housing rack apparatus 201 connected to the first connecting unit 401 and transmits a lowering command to the first apparatus 201a. On the other hand, the control unit 151 treats, as the second apparatus 201b, the basket housing rack apparatus 201 connected to the second connecting unit 402 and transmits a raising command to the second apparatus 201b.

Then, the control unit 251 of the basket housing rack apparatus 201 functioning as the first apparatus 201a determines that the raising and lowering command is received (Y in ACT 201) and controls the driving unit 213 to lower the rack 203 (ACT 202). The control unit 251 drives to rotate the motor M1 and actuates the pump P1 in a state in which the electromagnetic valve V1 is closed. In actuating the pump P1, the control unit 251 opens the electromagnetic valve V2. Then, the hydraulic cylinder 212 supplies the oil O to the lower chamber 214a while permitting the oil O to escape from the upper chamber 214b of the cylinder 214. Therefore, the hydraulic cylinder 212 drives the rod 215 in the projecting direction. Consequently, the driving unit 213 can fold the pantograph mechanism 209 and lower the rack 203. A falling amount of the rack 203 is equivalent to the height of one shopping basket SB.

On the other hand, the control unit 251 of the basket housing rack apparatus 201 functioning as the second apparatus 201b determines that the raising and lowering command is received (Y in ACT 201) and controls the driving unit 213 to raise the rack 203 (ACT 202). The control unit 251 drives to rotate the motor M2 and actuates the pump P2 in a state in which the electromagnetic valve V2 is closed. In actuating the pump P2, the control unit 251 opens the electromagnetic valve V1. Then, the hydraulic cylinder 212 supplies the oil O to the upper chamber 214b while permitting the oil O to escape from the lower chamber 214a of the cylinder 214. Therefore, the hydraulic cylinder 212 drives the rod 215 in the retracting direction. Consequently, the driving unit 213 can expand the pantograph mechanism 209 and raise the rack 203. A rising amount of the rack 203 is equivalent to the height of one shopping basket SB.

The control unit 151 of the checkout counter 101 increments a counter by one (ACT 103) and repeats the processing in ACT 101 to ACT 103 until the control unit 151 determines that count is up (Y in ACT 104). The number of counts at which it is determined that count is set to a number counted when a maximum number of shopping baskets SB are stacked on the rack 203 of the basket housing rack apparatus 201 functioning as the first apparatus 201a and all the shopping baskets SB are carried away from the rack 203 of the basket housing rack apparatus 201 functioning as the second apparatus 201b. The determination that count is up (Y in ACT 104) means that the number of shopping baskets SB housed in the first apparatus 201a reaches the maximum and no shopping basket SB is left in the second apparatus 201b.

When the control unit 151 of the checkout counter 101 determines that count is up (Y in ACT 104), the control unit 151 transmits a notification signal indicating to that effect to the POS terminal 301 (ACT 105), clears the counter (ACT 106), and finishes the processing. When the POS terminal 301 receives the notification signal from the checkout counter 101, as an example, the POS terminal 301 notifies information indicating that the first apparatus 201a and the second apparatus 201b should be interchanged.

In such a configuration, as explained above, the first apparatus 201a is located on the entrance side of the checkout counter 101 and the second apparatus 201b is located on the exit side of the checkout counter 101 (see FIG. 2). Therefore, the customer carries the shopping basket SB in which commodities A1 before commodity registration are stores to the basket housing rack apparatus 201 functioning as the first apparatus 201a (see FIG. 1). The customer stacks the shopping basket SB on the rack 203 of the first apparatus 201a.

The first apparatus 201a sets the height of the rack 203 such that the height of the stacked shopping basket SB at the top coincides with the height (certain reference height) of the counter top plate 102 of the checkout counter 101. More specifically, when the trigger signal transmitted from the POS terminal 301 to the checkout counter 101 is the closing signal and the customer stacks the shopping basket SB on the rack 203 of the first apparatus 201a, the first apparatus 201a causes the height of the shopping basket SB to coincide with the height of the counter top plate 102 on the checkout counter 101. On the other hand, when the trigger signal transmitted from the POS terminal 301 to the checkout counter 101 is a transaction start signal and the customer stacks the shopping basket SB on the rack 203 of the first apparatus 201a, the first apparatus 201a sets the height of the shopping basket SB larger than the height of the counter top plate 102 of the checkout counter 101 by the height of one shopping basket SB. This is because, in this case, the rack 203 of the first apparatus 201a is driven to be lowered by the height of one shopping basket SB according to barcode scan for the commodities A1 before commodity registration by the barcode reader 111 after that. Consequently, a store clerk who operates the barcode reader 111 can take out, in commodity registration work, the commodities A1 before commodity registration from the shopping basket SB stacked on the first apparatus 201a set to the same height as the counter top plate 102. Therefore, workability is improved.

The store clerk takes out the commodities A1 before commodity registration from the shopping basket SB stacked on the first apparatus 201a and reads barcodes (not shown in the figure) of the commodities A1 with the barcode reader 111. Then, the store clerk puts the commodities A1 in the shopping basket SB stacked on the second apparatus 201b one after another.

The second apparatus 201b sets the height of the rack 203 such that the height of the stacked shopping basket SB at the top coincides with the height (the certain reference height) of the counter top plate 102 of the checkout counter 101. More specifically, when the trigger signal transmitted from the POS terminal 301 to the checkout counter 101 is the closing signal, the second apparatus 201b causes the height of the shopping basket SB at the top stacked on the rack 203 of the second apparatus 201b to coincide with the height of the counter top plate 102 of the checkout counter 101. On the other hand, when the trigger signal transmitted from the POS terminal 301 to the checkout counter 101 is the transaction start signal, the second apparatus 201b sets the height of the shopping basket SB at the top stacked on the track 203 of the second apparatus 201b smaller than the height of the counter top plate 102 of the checkout counter 101 by the height of one shopping basket SB. This is because, in this case, the rack 203 of the second apparatus 201b is driven to be raised by the height of one shopping basket SB according to barcode scan for the commodities A1 before commodity registration by the barcode reader 111 after that. Consequently, the store clerk who operates the barcode reader 111 can store, in commodity registration work, the commodities in the second apparatus 201b set in the same height as the counter top plate 102 one after another. Therefore, workability is improved.

When commodity registration for all the commodities is finished, the store clerk performs closing processing in the POS terminal 301 and finishes the transaction according to payment for the commodities. The shopping basket SB stacked on the second apparatus 201b stores settled commodities A2 after commodity registration. The customer carries the shopping basket SB away from the second apparatus 201b.

The processing and the work explained above are repeated and transactions in the store progress one after another. When the shopping basket SB is placed on the rack 203, the first apparatus 201a falls by the height of the shopping basket SB. When the shopping basket SB is carried away from the rack 203, the second apparatus 201b rises by the height of the shopping basket SB. Consequently, roughly speaking, the height of the shopping basket SB at the top in the first apparatus 201a and the second apparatus 201b always coincides with the height of the counter top plate 102 of the checkout counter 101. Therefore, with the basket housing rack system according to this embodiment, it is possible to adopt an operation in which the customer is asked to stack the shopping basket SB that stores the commodities A1 before commodity registration on the rack 203 of the first apparatus 201a, the store clerk stores the commodities A2 after commodity registration one after another in the shopping basket SB stacked on the rack 203 of the second apparatus 201b, and the customer who finishes settlement only has to carry away the shopping basket SB in which the commodities A2 after commodity registration are stored. Therefore, the store clerk does not have to perform complicated work of moving the emptied shopping basket SB. Work efficiency of checkout work is remarkably improved.

When the maximum number of shopping baskets SB are stacked on the rack 203 of the basket housing rack apparatus 201 functioning as the first apparatus 201a and all the shopping baskets SB are carried away from the rack 203 of the basket housing rack apparatus 201 functioning as the second apparatus 201b, the checkout counter 101 transmits a notification signal to the POS terminal 301 (see ACT 105 in the flowchart of FIG. 8). Consequently, the POS terminal 301 notifies to that effect. At this timing, the store clerk interchanges the setting places of the first apparatus 201a and the second apparatus 201b. Specifically, the store clerk locates the basket housing rack apparatus 201 used as the first apparatus 201a on the right side of the checkout counter 101 and locates the basket housing rack apparatus 201 used as the second apparatus 201b on the left side of the checkout counter 101. Consequently, the connector 253 of the basket housing rack apparatus 201 arranged on the left side is connected to the connector 153a forming the first connecting unit 401 of the checkout counter 101. The connector 253 of the basket housing rack apparatus 201 arranged on the right side is connected to the connector 153b forming the second connecting unit 402. Both communication connection and power feed connection to the two basket housing rack apparatuses 201 are performed. In this case, the checkout counter 101 treats the basket housing rack apparatus 201 on the left side, the connector 253 of which is connected to the connector 153a forming the first connecting unit 401, as the first apparatus 201a and treats the basket housing rack apparatus 201 on the right side, the connector 253 of which is connected to the connector 153b forming the second connecting unit 402, as the second apparatus 201b (see ACT 102 in the flowchart of FIG. 8).

Therefore, with the method of controlling the basket housing rack apparatuses 201 according to this embodiment, simply by interchanging the arrangement positions of the first apparatus 201a and the second apparatus 201b at the timing explained above, it is possible to omit complicated work of replacing the shopping baskets SB such as shifting the shopping baskets SB stacked on the first apparatus 201a to the second apparatus 201b. Therefore, it is possible to remarkably improve work efficiency of checkout work.

Obviously, numerous modifications and variations of the present invention are possible in light of the above teachings. It is therefore to be understood that within the scope of the appended claims, the invention may be practiced otherwise than as specifically described herein.

What is claimed is:

1. A basket housing rack system comprising:
a first apparatus as a basket housing rack apparatus including a base set on a floor surface, a rack that is attached to the base to be freely raised and lowered and has a placing section for setting height of a shopping basket at a top to certain reference height and stackably placing plural shopping baskets, and a driving unit that drives to raise and lower the rack;
a second apparatus as a basket housing rack apparatus including a base set on a floor surface, a rack that is attached to the base to be freely raised and lowered and has a placing section for setting height of a shopping basket at a top to certain reference height and stackably placing plural shopping baskets, and a driving unit that drives to raise and lower the rack; and
control units that control to drive the driving unit of the first apparatus to lower the rack of the first apparatus and control to drive the driving unit of the second apparatus to raise the rack of the second apparatus according to a trigger signal transmitted from a commodity sales data processing apparatus.

2. The system of claim 1, further comprising a central control apparatus formed separately from the first apparatus and the second apparatus, wherein
the control units are provided to be distributed in the first apparatus, the second apparatus, and the central control apparatus.

3. The system of claim 2, further comprising a counter top plate set at the reference height, wherein
the central control apparatus is formed as a checkout counter having the counter top plate on an upper surface thereof.

4. The system of claim 2, further comprising:
a first connecting unit that connects the central control apparatus and the basket housing rack apparatuses to be capable of transmitting a signal to each other; and
a second connecting unit that connects the central control apparatus and the basket housing rack apparatuses to be capable of transmitting a signal to each other, wherein
the central control apparatus incorporates the control unit, and
the control unit treats, as the first apparatus, the basket housing rack apparatus connected by the first connecting unit and treats, as the second apparatus, the basket housing rack apparatus connected by the second connecting unit.

5. The system of claim 4, further comprising power feeding connection structures respectively provided in the first connecting unit and the second connecting unit to feed power from the central control apparatus to the first apparatus and the second apparatus.

6. The system of claim 4, wherein the first apparatus and the second apparatus are respectively arranged in certain positions adjacent to the central control apparatus, whereby the first connecting unit and the second connecting unit connect the first apparatus and the second apparatus to the central control apparatus.

7. The system of claim 6, wherein the basket housing rack apparatuses have casters in setting sections for setting the basket housing rack apparatuses on a floor.

8. A basket housing rack apparatus control method for a pair of basket housing rack apparatuses including bases set on a floor surface, racks that are attached to the bases to be freely raised and lowered and have placing sections for setting height of a shopping basket at a top to certain reference height and stackably placing plural shopping baskets, and driving units that drive to raise and lower the racks, a central control apparatus being connected to the basket housing rack apparatuses to be capable of transmitting a signal via a first connecting unit and a second connecting unit, respectively, and having a checkout counter set at certain reference height on an upper surface thereof, the basket housing rack apparatus control method comprising:
the central control apparatus receiving a trigger signal transmitted from a commodity sales data processing apparatus;
the central control apparatus controlling to drive the driving unit of the basket housing rack apparatus to lower the rack of the basket housing rack apparatus connected to the first connecting unit according to the received trigger signal; and
the central control apparatus controlling to drive the driving unit of the basket housing rack apparatus to raise the rack of the basket housing rack apparatus connected to the second connecting unit.
